(19) United States
(12) Patent Application Publication
(10) Pub. No.: US 2011/0234889 A1
(43) Pub. Date: Sep. 29, 2011

(54) MONITORING CAMERA

(75) Inventor: CHEN-SHUN SU, Taipei City (TW)

(73) Assignee: CWELL VISION CO., LTD., Taipei (TW)

(21) Appl. No.: 12/732,348

(22) Filed: Mar. 26, 2010

(51) Int. Cl. H04N 5/225; H04N 7/18

(52) U.S. Cl. 348/373; 348/E07.085; 348/E05.024

(57) ABSTRACT

A monitoring camera including a housing, a sliding chute, an image capturing unit, an adjusting screw, and a cabin door is provided. The housing has a groove formed on one side. The sliding chute is disposed on a bottom surface of the groove. The image capturing unit is accommodated in the housing to capture images, and has an optical adjusting ring for adjusting optical properties of the image capturing unit. The adjusting screw is disposed on the sliding chute and is connected to the optical adjusting ring via a connection unit. The cabin door is pivoted to the groove, and when the cabin door is closed, a force is provided to press the adjusting screw, such that the adjusting screw is fixed on the bottom surface of the groove.

### BACKGROUND OF THE INVENTION

1. Field of the Invention

The present invention relates to a monitoring camera, and more particularly to a monitoring camera with a function of fixing an adjusting screw.

2. Related Art

Monitoring cameras play an important role in modern life, and are commonly used in streets and avenues, offices, and other important places where monitoring cameras have become an indispensable security device. An ordinary shop owner may use monitoring cameras to monitor whether there is a person taking advantage of the chaos and stealing goods, and watch the shop after the shop is closed at night, so as to save the labor cost. A company or enterprise may use monitoring cameras to monitor the behaviors of employees, and monitor activities in the company during off-duty hours and keep records, so as to protect the assets of the company. Therefore, the monitoring camera not only provides functions of evidence collection, evidence preservation, and surveillance, but also effectively prevents criminal activities, which thus becomes an indispensable assistant in daily life.

Generally, when using a monitoring camera, a user needs to select a suitable angle and a suitable shooting position, and to adjust a focal range (image capturing distance) and a focusing status of the monitoring camera, so as to enable the monitoring camera to obtain clear pictures. Unfortunately, the desirable shooting angle and shooting direction cannot be easily determined merely after the monitoring camera is adjusted for once or twice, and actually, a focal range ring and a focusing ring have to be continuously adjusted for achieving the best shooting effects. However, considering a monitoring camera in the prior art, the user needs to separate (detach) a cover at a front end from a camera body at a rear end, exposes a lens to facilitate the adjustment of the focal length, and then releases the locked focal range ring and focusing ring, so as to adjust the focal range ring and the focusing ring. The above process is complex and somewhat difficult to carry out, and causes troubles to the user in usage.

Therefore, it is necessary to provide a monitoring camera to solve the problems of the prior art.

### SUMMARY OF THE INVENTION

In view of the defects of the prior art, the present invention is directed to a monitoring camera, in which at least one groove is formed to enable an adjusting screw slideably disposed in the at least one groove to be exposed to the exterior, so that the user can change optical properties of an image capturing unit by adjusting the adjusting screw without opening a front end and a rear end of the monitoring camera mechanism to expose a lens for adjusting a focal length. In addition, the adjusting screw is pressed by using a weight of a cabin door after the cabin door is closed, such that the adjusting screw is fixed under a force provided by the cabin door instead of being tightly locked, thereby preventing the adjusting screw from sliding due to being loosened. Therefore, the user can directly adjust the adjusting screw with hands without using any auxiliary tool to loosen the adjusting screw, thereby improving the convenience in use.

In an embodiment, the present invention provides a monitoring camera, which includes: a housing, having a groove formed on one side thereof; a sliding chute, disposed on a bottom surface of the groove; an image capturing unit, accommodated in the housing to capture images, and having an optical adjusting ring for adjusting optical properties of the image capturing unit; an adjusting screw, disposed on the sliding chute and connected to the optical adjusting ring via a connection unit, in which the adjusting screw slides on the sliding chute to drive the connection unit to rotate the optical adjusting ring, thereby changing the optical properties of the image capturing unit; and a cabin door, pivoted to the groove, in which when the cabin door is closed, a force is provided to press the adjusting screw, such that the adjusting screw is fixed under the force provided by the cabin door, without being tightly locked on the sliding chute.

In another embodiment, the present invention provides a monitoring camera, which includes: a housing, having a groove formed on one side thereof; two sliding chutes, disposed on a bottom surface of the groove; an image capturing unit, accommodated in the housing to capture images, and having a set of optical adjusting rings for respectively adjusting an image capturing distance and a focusing status of the image capturing unit; two adjusting screws, respectively disposed on the two sliding chutes, and connected to the corresponding optical adjusting ring via a connection unit, in which each of the adjusting screws slides on the sliding chute to drive the connection unit to rotate the optical adjusting ring, thereby changing optical properties of the image capturing unit; and a cabin door, pivoted to the groove, in which when the cabin door is closed, a force is provided to press the two adjusting screws, such that the two adjusting screws are fixed under the force provided by the cabin door, without being tightly locked on the sliding chutes.

### BRIEF DESCRIPTION OF THE DRAWINGS

FIG. 1 is a three-dimensional schematic view of an embodiment of the present invention;

FIG. 2 is a schematic view of a connection between an adjusting screw and a connection unit according to the present invention;

FIG. 3 is a schematic view of a locking manner of a cabin door according to the present invention;

FIGS. 4A and 4B are schematic views of fixing an adjusting screw according to the present invention;

FIG. 5 is a partially enlarged view of a groove in the embodiment shown in FIG. 1 according to the present invention;

FIG. 6 is a schematic view of assembling a base according to the present invention; and

FIG. 7 is a three-dimensional schematic view of another embodiment of the present invention.

### DETAILED DESCRIPTION OF THE INVENTION

In order to make the features, objectives, and functions of the present invention more comprehensible, the related detailed structures and design ideas and reasons of the device of the present invention are illustrated below, so that the Examiner can understand the characteristics of the present invention. The detailed illustration is as follows.

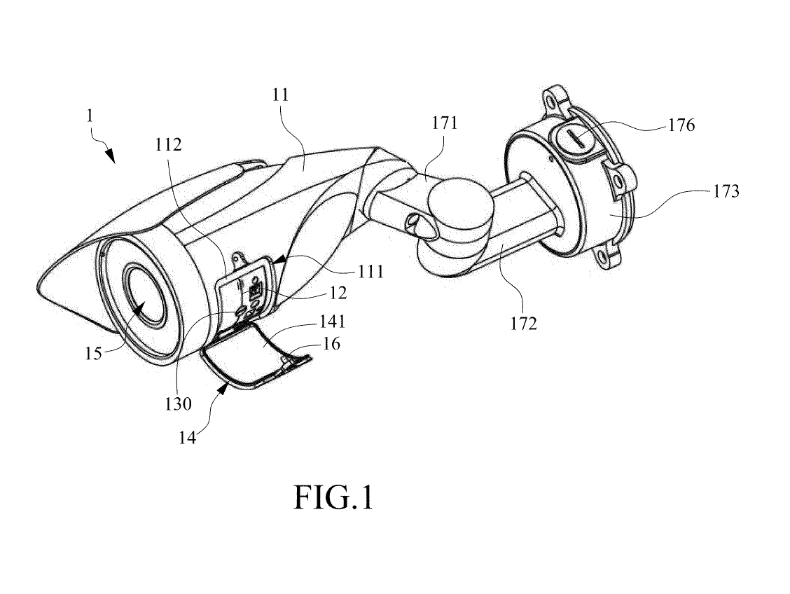

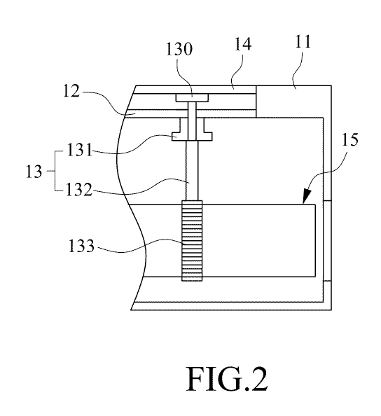

FIG. 1 is a three-dimensional schematic view of an embodiment of the present invention. Referring to FIG. 1, in this embodiment, a monitoring camera 1 includes a housing 11, a sliding chute 12, an adjusting screw 130, a cabin door 14, and an image capturing unit 15. The housing 11 has a groove 111 formed on one side thereof. The sliding chute 12 is disposed on a bottom surface of the groove 111. The adjusting screw 130 is slideably disposed on the groove 111. FIG. 2 is a schematic view of a connection between an adjusting screw and a connection unit according to the present invention. Referring to FIG. 2, the image capturing unit 15 is accommodated in the housing 11. In this embodiment, the image capturing unit 15 may be a charge-coupled device (CCD) or complementary metal-oxide-semiconductor (CMOS) image sensing unit or an image capturing unit with an infrared night vision capability. The image capturing unit 15 has an optical adjusting ring 133 coupled thereto, and the optical adjusting ring 133 adjusts optical properties of the image capturing unit 15 by using a rotation motion. In this embodiment, the optical adjusting ring 133 is capable of adjusting an image capturing distance or a focusing status of the image capturing unit 15. The adjusting screw 130 passes through the sliding chute 12 and is connected to the optical adjusting ring 133 via a connection unit 13.

In addition, the connection unit 13 has an adjusting base 131 and an adjusting rod 132. The adjusting screw 130 passes through the sliding chute 12 and is connected to the adjusting base 131 and thus connected to the adjusting rod 132. An other end of the adjusting rod 132 is connected to the optical adjusting ring 133. The adjusting screw 130 may slide on the sliding chute 12 to drive the connection unit 13 to rotate the optical adjusting ring 133, thereby changing the optical properties of the image capturing unit 15. In this embodiment, the optical properties may be a focal range (that is, image capturing distance) or focusing status, so as to enable the monitoring camera 1 to focus on a place to be shot and capture clear images.

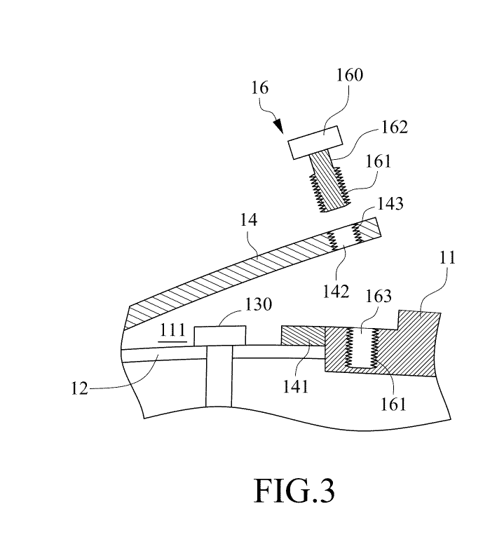

Referring to FIG. 1 again, the cabin door 14 is pivoted to the groove 111, and when the cabin door 14 is closed, a force is provided due to a weight of the cabin door 14, so as to press the adjusting screw 130, thereby fixing the adjusting screw 130 on the sliding chute 12, and preventing the adjusting screw 130 from sliding due to being loosened. Through the design of the cabin door 14 of the monitoring camera 1, the user can adjust the optical properties of the image capturing unit 15 by using the adjusting screw 130 after opening the cabin door 14, instead of opening the front end and the rear end of the mechanism of the monitoring camera 1. FIG. 3 is a schematic view of a locking manner of a cabin door according to the present invention. Referring to FIG. 3, the cabin door 14 further has a through hole 142 with threads 143 formed on an inner wall thereof. The through hole 142 is configured to be threaded with a locking screw 16 for locking the cabin door 14 on the housing 11. The locking screw 16 is a tamper-proof hexagon locking screw 16, and has a thread portion 161, a nut portion 160, and a cylinder 162 having a diameter smaller than that of the thread portion and the nut portion. When the cabin door 14 is opened, the cylinder 162 of the locking screw 16 is disposed in the through hole 142 corresponding to the inner wall of the through hole, so as to prevent the locking screw 16 from falling off.

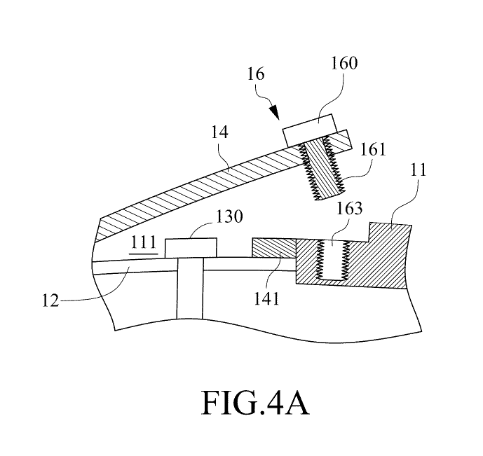

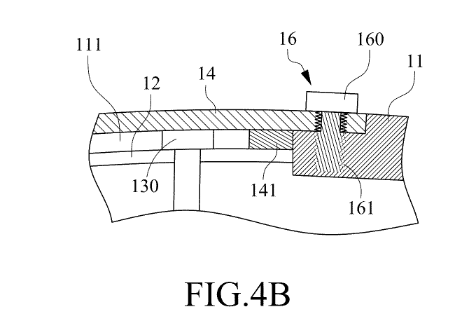

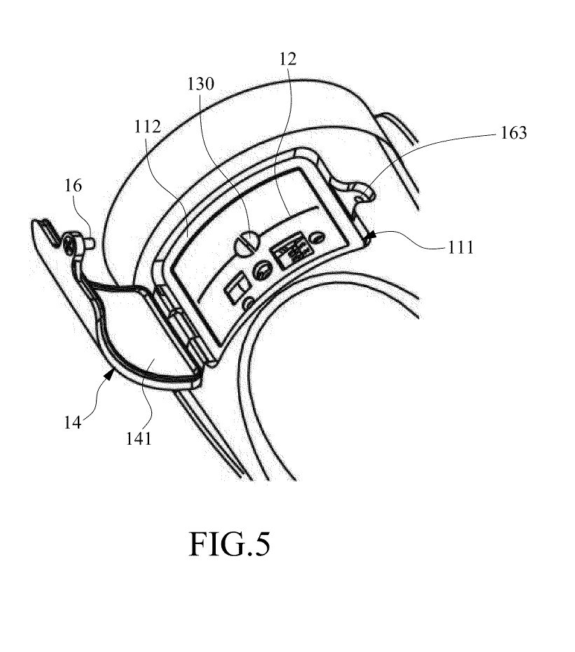

In order to facilitate the user to adjust the adjusting screw 130, the design of the present invention enables the user to directly loosen the adjusting screw with hands without using any auxiliary tool, thereby adjusting the optical properties of the image capturing unit 15 by moving the adjusting screw 130, and the design concept is as follows. FIGS. 4A and 4B are schematic views of fixing an adjusting screw according to the present invention. As shown in FIG. 4A, when the adjusting screw 130 completes the focal range or focusing adjustment, the user only needs to slightly tighten the adjusting screw 130 to gently contact the sliding chute 12. Then, when the cabin door 14 is closed, the cabin door 14 provides a force to press against the adjusting screw 130, such that the adjusting screw 130 is fixed and positioned under the force without being tightly locked on the sliding chute 12, as shown in FIG. 4B. Moreover, it should be noted that, the user may also tightly lock the adjusting screw 130 on the sliding chute 12, and then lock the cabin door 14 on the housing 11. FIG. 5 is a partially enlarged view of a groove in the embodiment shown in FIG. 1 according to the present invention. Referring to FIG. 5, in this embodiment, a cushion 141 is attached to a wall surface of the cabin door 14 contacting the adjusting screw. When the locking screw 16 of the cabin door is tightly locked, the cushion 141 presses the adjusting screw 130, such that the adjusting screw 130 transmits the pressing force to the optical adjusting ring 133 via the connection unit 13, thereby achieving a fixed focal length or focal range. The cushion 141 may be formed by a cushioning material such as a foam pad or rubber, so as to prevent the adjusting screw 130 from defocusing or having focal range offset due to vibration. Moreover, a waterproof pad 112 is arranged around the bottom surface of the groove 111, such that a closely attached effect is achieved when the cabin door 14 is closed, thereby preventing rainwater and dust from entering the housing 11.

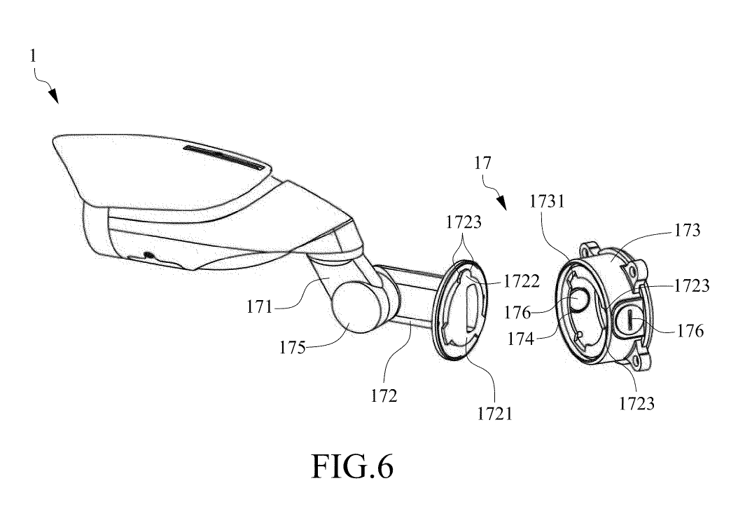

Moreover, at places difficult for construction, a locking module may be additionally disposed on one side of the housing according to requirements of the user, so as to facilitate the assembly carried out by a constructor. FIG. 6 is a schematic view of a locking module according to the present invention. Referring to FIG. 6, a locking module 17 includes an upper bracket 171, a lower bracket 172, and a base 173. The upper bracket 171 is connected to a tail end of the housing 11, and an other side of the upper bracket 171 is coupled to the lower bracket 172. A pivot 175 is disposed at the coupling position. The pivot 175 has a gear assembly disposed therein, which enables the upper bracket 171 and the lower bracket 172 to rotate relative to each other. The gear assembly belongs to the prior art, and the details are not described herein again. Moreover, one end of the lower bracket has a plate body 1721, a plurality of catches 1722 is distributed on the plate body 1721, and one of the catches 1722 at least has a chamfer 1723, so as to provide a foolproof measure for the constructor during assembly. The base 173 has a plurality of slots 1731 distributed thereon, and the plurality of slots 1731 is corresponding to a shape of the catch 1722. The base 173 may be locked at the place to be shot, and the slots 1731 at an other end are configured for being embedded by the catches 1722. After the embedding motion, the plurality of catches 1722 is rotated to the wall surface between the slots 1731, so as to prevent the lower bracket 172 from detaching from the base 173, thereby mounting and fixing the monitoring camera to the place to be shot. In addition, at least one wire outlet 174 is formed on the base 173. In the embodiment of FIG. 6, two wire outlets are shown. Threads are formed on an inner wall of each of the wire outlets 174, and when not being used, each of the wire outlets 174 may be threaded with a plug 176, so as to be blocked. It should be noted that, although the threads are formed on the inner wall of the wire outlets 174 in this embodiment, wire outlets 174 without threads may also be implemented in another embodiment dependent upon the application requirements, and the present invention is not limited here. Therefore, when the wire is intended to be connected, the constructor takes out the plug 176, and then threads an adaptor onto the wire outlet 174, in which the wire outlet 174 allows Bayonet Neill-Concelman (BNC) coaxial signal lines and power cables to pass through, such that the coaxial signal lines and power cables are electrically connected to the monitoring camera 1.

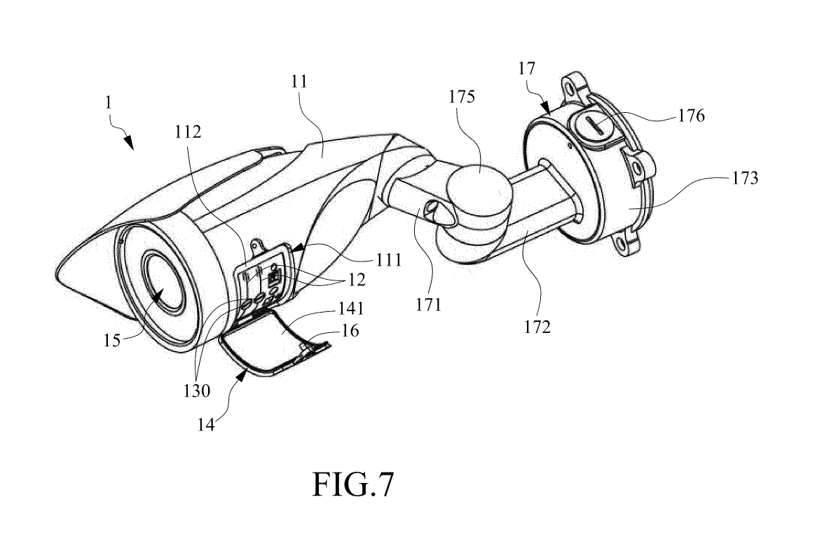

FIG. 7 is a three-dimensional schematic view of another embodiment of the present invention. The embodiment of FIG. 1 is mainly an embodiment directed to a single adjusting screw, and the embodiment of FIG. 7 is an embodiment having two adjusting screws. Referring to FIG. 7, in this embodiment, a monitoring camera 1 includes a housing 11, two sliding chutes 12, two adjusting screws 130, a cabin door 14, and an image capturing unit 15. The embodiment of FIG. 7 is similar to that of FIG. 1, and the difference there-between is that, two sliding chutes 12 are disposed on the bottom surface of the groove 111 and are slideably connected to the two adjusting screws 130 respectively. The two adjusting screws 130 pass through the sliding chutes 12 and are respectively connected to two optical adjusting rings 133 via two connection units 13, so as to adjust the optical properties of the image capturing unit. In this embodiment, the two optical adjusting rings 133 are respectively a focusing ring for adjusting the focusing status of the image capturing unit 15 and a focal range ring for adjusting the image capturing distance of the image capturing unit 15. The cabin door 14 is pivoted to the groove 111, and when the cabin door 14 is closed, a force is provided due to a weight of the cabin door 14 to press the two adjusting screws 130, such that the two adjusting screws 130 are fixed without being tightly locked on the sliding chutes 12, thereby preventing the adjusting screws 130 from sliding due to being loosened. Moreover, through the design of the cabin door of the monitoring camera, the user can adjust the optical properties of the image capturing unit by using the adjusting screw after opening the cabin door, instead of opening the front end and the rear end of the mechanism of the monitoring camera, and after the adjustment, a force for fixing the adjusting screws is provided by means of closing the cabin door, so as to avoid the displacement of the adjusting screws. The structures and principles of other components have been described above, and the details are not described herein again.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A monitoring camera, comprising:
a housing, having a groove formed on one side thereof;
a sliding chute, disposed on a bottom surface of the groove;
an image capturing unit, accommodated in the housing to capture images, and having an optical adjusting ring for adjusting optical properties of the image capturing unit;
an adjusting screw, disposed on the sliding chute and connected to the optical adjusting ring via a connection unit, wherein the adjusting screw slides on the sliding chute to drive the connection unit to rotate the optical adjusting ring, thereby changing the optical properties of the image capturing unit; and
a cabin door, pivoted to the groove, wherein when the cabin door is closed, a force is provided to press the adjusting screw, such that the adjusting screw is fixed under the force without being tightly locked on the sliding chute.

2. The monitoring camera according to claim 1, wherein the connection unit has an adjusting base and an adjusting rod, the adjusting base is threaded on the adjusting screw, one end of the adjusting rod is connected to the adjusting base, and an other end of the adjusting rod is connected to the optical adjusting ring.

3. The monitoring camera according to claim 1, wherein a cushion is attached to a wall surface of the cabin door contacting the adjusting screw.

4. The monitoring camera according to claim 1, wherein a waterproof pad is arranged around the bottom surface of the groove.

5. The monitoring camera according to claim 1, wherein the cabin door further has a through hole with threads formed on an inner wall thereof, the through hole is configured to be threaded with a locking screw for locking the cabin door on the housing, the locking screw has a thread portion, a nut portion, and a cylinder having a diameter smaller than that of the thread portion and the nut portion, and when the locking screw is threaded in the through hole, the cylinder is corresponding to the inner wall of the through hole, so as to prevent the locking screw from falling off.

6. The monitoring camera according to claim 1, further comprising: a locking module, wherein the locking module comprises:
an upper bracket, connected to the housing;
a lower bracket, coupled to the upper bracket, so as to enable the upper bracket and the lower bracket to rotate relative to each other, wherein one end of the lower bracket has a plate body, a plurality of catches is distributed on the plate body, and one of the catches at least has a chamfer; and
a base, having a plurality of slots distributed thereon, wherein the plurality of slots is respectively corresponding to shapes of the plurality of catches.

7. The monitoring camera according to claim 6, wherein a wire outlet is formed on left and right sides of the base respectively.

8. The monitoring camera according to claim 7, wherein threads are formed on an inner wall of the wire outlet.

9. The monitoring camera according to claim 1, wherein the optical adjusting ring is capable of adjusting an image capturing distance or a focusing status of the image capturing unit.

10. A monitoring camera, comprising:
a housing, having a groove formed on one side thereof;
two sliding chutes, disposed on a bottom surface of the groove;
an image capturing unit, accommodated in the housing to capture images, and having a set of optical adjusting rings for respectively adjusting an image capturing distance and a focusing status of the image capturing unit;
two adjusting screws, respectively disposed on the two sliding chutes, and connected to the corresponding optical adjusting ring via a connection unit, wherein each of the adjusting screws slides on the sliding chute to drive the connection unit to rotate the optical adjusting ring, thereby changing optical properties of the image capturing unit; and
a cabin door, pivoted to the groove, wherein when the cabin door is closed, a force is provided to press the two adjusting screws, such that the two adjusting screws are fixed under the force without being tightly locked on the sliding chutes.

11. The monitoring camera according to claim 10, wherein the connection unit has an adjusting base and an adjusting rod, the adjusting base is threaded on the adjusting screw, one end of the adjusting rod is connected to the adjusting base, and an other end of the adjusting rod is connected to the corresponding optical adjusting ring.

12. The monitoring camera according to claim 10, wherein a cushion is attached to a wall surface of the cabin door contacting each of the adjusting screws.

13. The monitoring camera according to claim 10, wherein a waterproof pad is arranged around the bottom surface of the groove.

14. The monitoring camera according to claim 10, wherein the cabin door further has a through hole with threads formed on an inner wall thereof, the through hole is configured to be threaded with a locking screw for locking the cabin door on the housing, the locking screw has a thread portion, a nut portion, and a cylinder having a diameter smaller than that of the thread portion and the nut portion, and when the locking screw is threaded in the through hole, the cylinder is corresponding to the inner wall of the through hole, so as to prevent the locking screw from falling off.

15. The monitoring camera according to claim 10, further comprising: a locking module, wherein the locking module comprises:
an upper bracket, connected to the housing;
a lower bracket, coupled to the upper bracket, so as to enable the upper bracket and the lower bracket to rotate relative to each other, wherein one end of the lower bracket has a plate body, a plurality of catches is distributed on the plate body, and one of the catches at least has a chamfer; and
a base, having a plurality of slots distributed thereon, wherein the plurality of slots is corresponding to a shape of the catch.

16. The monitoring camera according to claim 15, wherein a wire outlet is formed on left and right sides of the base respectively.

17. The monitoring camera according to claim 16, wherein threads are formed on an inner wall of the wire outlet.
